(19) United States
(12) Patent Application Publication
(10) Pub. No.: US 2017/0193622 A1
(43) Pub. Date: Jul. 6, 2017

(54) Method of Remotely Monitoring and Tracking Individuals Under Probation and/or House Arrest

(71) Applicant: Maison R. Rosado, Sunrise, FL (US)

(72) Inventor: Maison R. Rosado, Sunrise, FL (US)

(21) Appl. No.: 15/397,615

(22) Filed: Jan. 3, 2017

Related U.S. Application Data
(60) Provisional application No. 62/273,801, filed on Dec. 31, 2015.

(51) Int. Cl. G06Q 50/26; G06Q 20/10; H04W 64/00; H04L 29/06

(52) U.S. Cl. CPC G06Q 50/26; H04L 63/08; G06Q 20/10; H04W 64/003; G06Q 10/109

(57) ABSTRACT

A method of remotely monitoring and tracking individual under probation and/or house arrest is executed in between a user account and an administrative account that are managed by a remoter server. The remote server tracks a geospatial path of a personal computing (PC) device that is associated with the user account to determine the current location of the user. The remote server sends out automated check-in requests to the PC device so that the user can be tracked according to uploaded scheduled events of the user account. The remote server sends out random check-in requests to the PC device to keep track of the activities of the user. The user account requires to respond to the check-in request with a check-in location and/or a check-in time with the PC device so that the method is able to accurately monitor the user activities throughout the probation and/or house arrest time period.

The current application claims a priority to the U.S. Provisional Patent application Ser. No. 62/273,801 filed on Dec. 31, 2015. The current application is filed on Jan. 3, 2017 while Dec. 31, 2015 was on a weekend and Jan. 2, 2017 was an observed holiday.

### FIELD OF THE INVENTION

The present invention relates generally to the mobile application. More specifically, the present invention provides an efficient process of remotely monitor and track low risk offenders that are either under house arrest, administrative probation, parole, and/or probation with global positioning system technology and biometric technology.

### BACKGROUND OF THE INVENTION

An ankle monitor, also known as a tether or ankle bracelet, is an electronic device that individuals under house arrest or parole are often required to wear. At timed intervals, the ankle monitor sends a radio frequency signal containing location and other information to an administrative receiver. If an offender moves outside of an allowed range, the responsible authorities are notified. The criminal justice system utilizes several different models of ankle monitors, but most of those models work in essentially the same way as described above. The ankle monitors are designed to be tamper-resistant and can alert authorities in an attempt of removal, such as cutting the conductive band causing a circuit break. In addition, the ankle monitor may be programmed to allow an individual to roam freely within a certain area and may have GPS monitoring functions that alert the monitoring station if the respective individual goes outside of the permitted area.

It is an objective of the present invention to replace the ankle monitor that house arrested individuals are often required to wear. The present invention allows an individual replace the ankle monitor as their prosecuting officer can track and monitor the individual's activities in relation to a pre-scheduled daily roster managed by an administrative account.

### BRIEF DESCRIPTION OF THE DRAWINGS

FIG. 1 is a flowchart showing the overall process of the present invention.

FIG. 2 is a flowchart showing the completion of the user profile within the overall process of the present invention.

FIG. 3 is a flowchart showing the completion of the case profile within the overall process of the present invention.

FIG. 4 is a flowchart showing the completion of the payment option within the overall process of the present invention.

FIG. 5 is a flowchart showing the document uploading feature within the overall process of the present invention.

FIG. 6 is a flowchart showing the completion of the schedule by the user account within the overall process of the present invention.

FIG. 7 is a flowchart showing the completion of the schedule by the administrative account within the overall process of the present invention.

FIG. 8 is a flowchart showing the approval status for the automated check-in request within the overall process of the present invention.

FIG. 9 is a flowchart showing the denial status for the automated check-in request within the overall process of the present invention, wherein the check-in location does not match with the event location.

FIG. 10 is a flowchart showing the denial status for the automated check-in request within the overall process of the present invention, wherein the check-in time is different from the event time.

FIG. 11 is a flowchart showing the denial status for the automated check-in request within the overall process of the present invention, wherein the check-in time is outside of a preset time-period.

FIG. 12 is a flowchart showing the denial status for the automated check-in request within the overall process of the present invention, wherein check-in location does not match with the event location and the check-in time is outside of a preset time-period.

FIG. 13 is a flowchart showing the denial status for the automated check-in request within the overall process of the present invention, wherein check-in location does not match with the event location and the check-in time is different from the event time.

FIG. 14 is a flowchart showing the approval status for the random check-in request within the overall process of the present invention.

FIG. 15 is a flowchart showing the denial status for the random check-in request within the overall process of the present invention.

### DETAIL DESCRIPTIONS OF THE INVENTION

All illustrations of the drawings are for the purpose of describing selected versions of the present invention and are not intended to limit the scope of the present invention.

The present invention is a method of remotely monitoring and tracking individual under probation and/or house arrest. The present invention is preferably designed as a mobile application or a web application so that the present invention is able to remotely monitor and track low risk offenders that are either probation or house arrest by utilizing mobile network technology and global positioning system (GPS). The present invention essentially replaces the traditional ankle bracelet which certain offenders are obliged to wear.

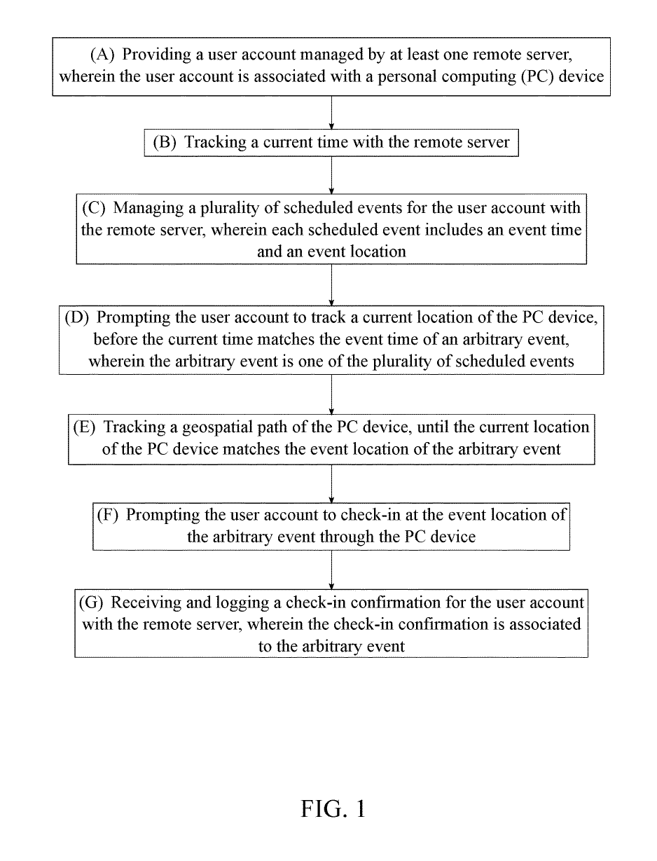

The system executes the method of the present invention includes at least one remote server, a user account, and an administrative account as shown in FIG. 1. The user account and the administrative account are created on the present invention as both accounts interact with each other to complete the overall process of the present invention. The remote server, which manages the interaction between the user account and the administrative account, executes some internal processes of the present invention. More specifically, an individual under probation and/or house arrest creates the user account through a personal computing (PC) device so that the user account can subscribe to an electronic monitoring and tracking process of the present invention. The remote server is then able to identify the individual under probation and/or house arrest as the user account, and, thus the remote server manages the user account. An individual that acts as a supervising/monitoring agent for the user account creates the administrative account through an administrative computing (AC) device so that the administrative account can manage the subscribed user account. Similar to the user account, the remote server is then able to identify the supervising/monitoring individual as the administrative account, and, thus the remote server provides access to the user account.

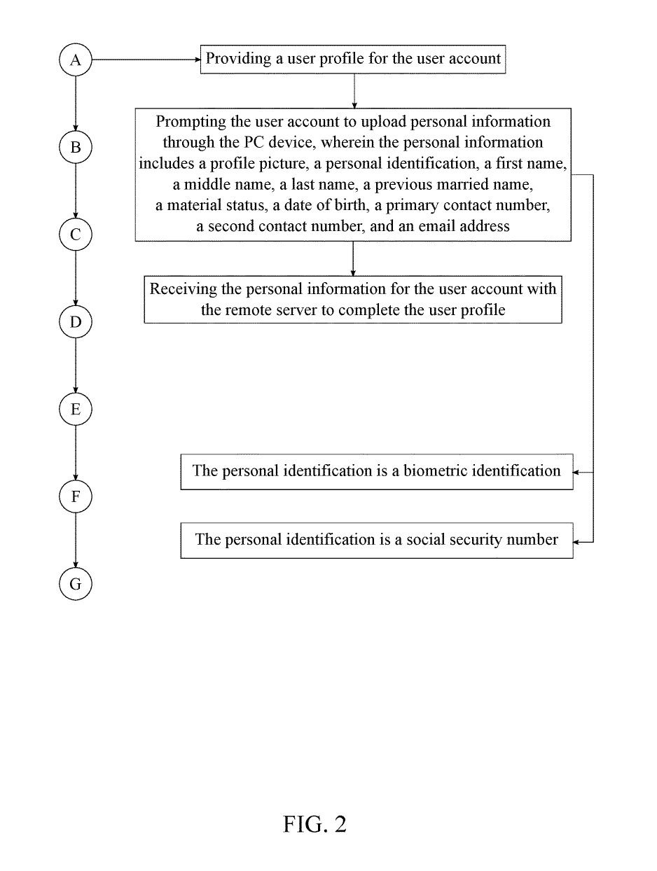

In reference to FIG. 2, the user account includes a user profile, wherein the user profile is required to complete before accessing the overall process of the present invention. More specifically, A user first submits basic user information and an email address to sign-up for the present invention. upon successful submission of the basic user information and the email address, the remote server then sends a confirmation email to the registered email address. The user can then access the present invention through the confirmation email to set up the password thus completing the sign-up process. Additionally, the present invention also enables the user to recover and reset the password if the existing password is forgotten. Once the sign-up process is completed, the user can simply enter the registered email and the password to access the present invention. The present invention then prompts the user account to upload personal information through the PC device. The personal information includes a profile picture, a personal identification, a first name, a middle name, a last name, a previous married name, a material status, a date of birth, a primary contact number, a second contact number, and an email address that is preferably autofill from the registered email address. Depending upon the specifications of the PC device, the personal identification can differ to improve the operating efficiency of the present invention. For example, when the PC device is equipped with a biometric scanner, the user account is authenticated through a biometric identification of the user in which the biometric identification functions as the personal identification. When the PC device does not have a biometric scanner, the user account is authenticated through a social security number of the user in which the social security number functions as the personal identification. Once the remote server receives the personal information for the user account, the remote server is able to partially complete the user profile for the user account.

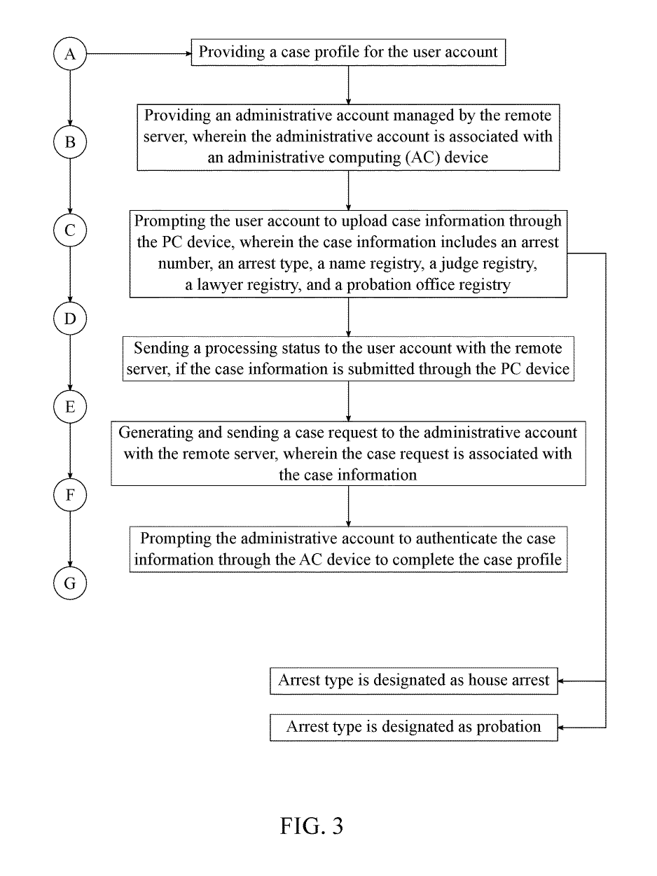

In reference to FIG. 3, the user account includes a case profile, wherein the case profile is required to complete before accessing the overall process of the present invention. More specifically, the present invention prompts the user account to upload case information through the PC device, wherein the case information includes an arrest number, an arrest type, a name registry, a judge registry, a lawyer registry, and a probation office registry. Once the case information is submitted through the PC device, the remote server sends a processing status to the user account indicating that the case information is now being reviewed. The remote server then generates and sends a case request to the administrative account, wherein the case request is associated with the case information. The remote server then prompts the administrative account to authenticate the case information through the AC device. After the remote server receives the authentication for the case information for the administrative account, the remote server is able to fully complete the user profile for the user account.

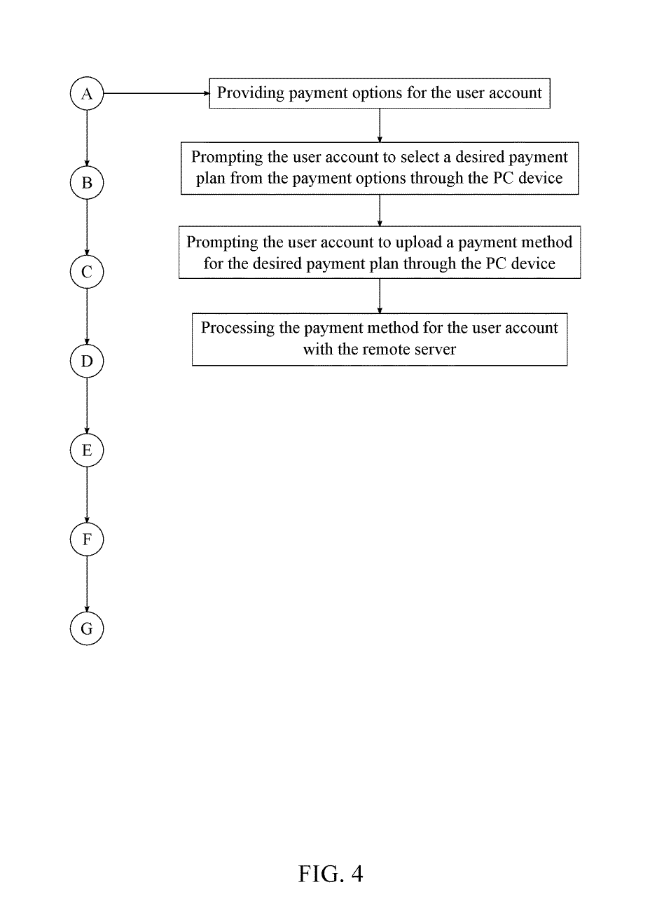

In reference to FIG. 4, upon completion of the user account, the present invention displays payment options for the user account through the PC device. More specifically, the remote server prompts the user account to select a desired payment plan from the payment options through the PC device. The payment options include, but is not limited to, a quarterly payment, a yearly payment, and an unlimited payment as each different payment option provides different payment period that corresponds to the probation and/or house arrest time duration. As a result, the user account is able to select the correct payment option as the desired payment plan. Then, the user account is prompted to upload a payment method for the desired payment plan through the PC device to finalizing the financial transaction. The remote server then processes the payment method for the user account completing the payment option feature of the present invention and grating full access to the present invention.

In order to execute the overall process of the present invention, the remoter server continuously tracks a current time so that a plurality of scheduled events for the user account can be accurately managed. In reference to FIG. 1, each of the scheduled event includes an event time and an event location as each scheduled event can be uploaded by the user account or the administrating account.

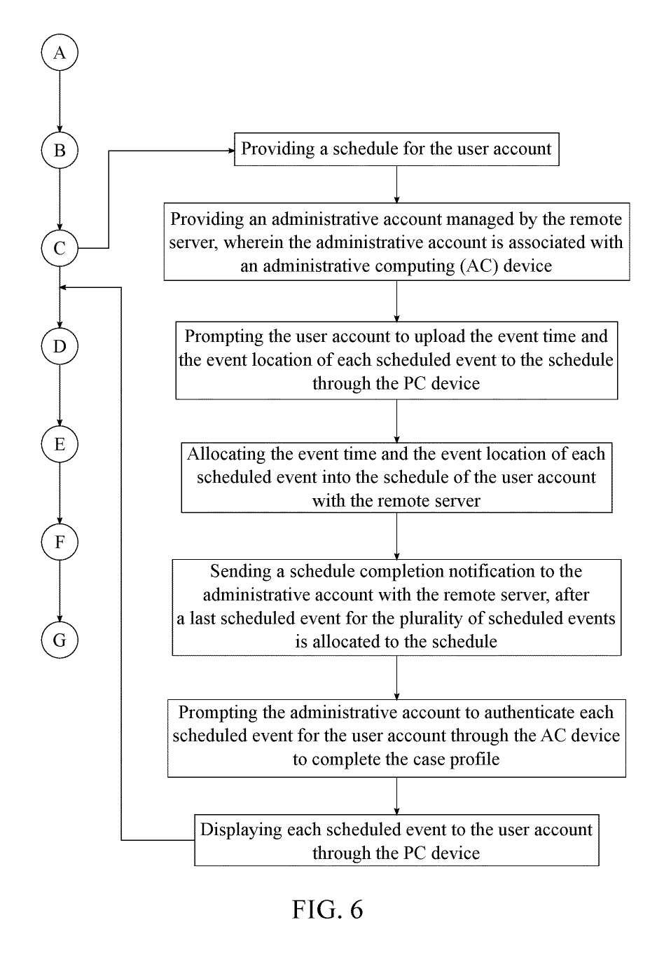

In reference to FIG. 6, when the case type is designated as house arrest for the case profile, the remote server prompts the user account to upload each scheduled event. For example, when the event location for a large set of the plurality of scheduled events is restricted to a home address of the user account or house arrest designation is stated within court documents that are uploaded or provided to the administrative account, the present invention validates that the case type is designated as house arrest. The remote server then prompts the user account to upload the event time and the event location of each scheduled event to a schedule of the user account through the PC device. The remote server then allocates the event time and the event location of each scheduled event into the schedule of the user account. After a last scheduled event for the plurality of scheduled events is allocated to the schedule, the remote server sends a schedule completion notification to the administrative account and prompts the administrative account to authenticate each scheduled event for the user account through the AC device. After each scheduled event is approved by the administrative account, each scheduled event is shown with the schedule and displayed to the user account the PC device.

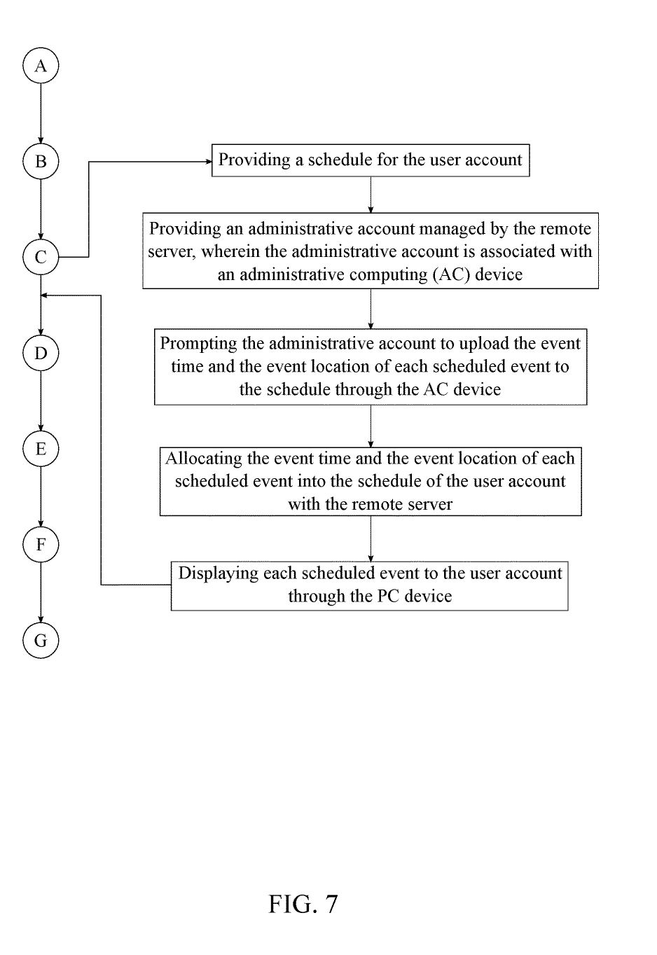

In reference to FIG. 7, when the case type is designated as probation for the case profile, the remote server prompts the administrative account to upload each scheduled event that are provided by the presiding probation officer. For example, when the event location for a large set of the plurality of scheduled events is unrestricted to a home address of the user account or probation designation is stated within court documents that are uploaded or provided to the administrative account, the present invention validates that the case type is designated as probation. The remote server then prompts the administrative account to upload the event time and the event location of each scheduled event to a schedule of the user account through the AC device. The remote server then allocates the event time and the event location of each scheduled event into the schedule of the user account with the remote server. Since each scheduled event is uploaded by the administrative account, the remote server does not require an authentication process for each scheduled event. As a result, each scheduled event is shown with the schedule and displayed to the user account the PC device.

In reference to FIG. 1, the present invention allows the user travel and move to various location, however, the remote sever constantly monitors and tracks the user through the PC device and a map feature of the user account. Upon accessing the map feature, the remote server is able to continuously monitor and track a current location of the PC device before the current time matches the event time of an arbitrary event, wherein the arbitrary event is one of the plurality of scheduled events. As a result, the remote server is able to track a geospatial path of the PC device, until the current location of the PC device matches the event location of the arbitrary event. The remote server then prompts the user account to check-in at the event location of the arbitrary event through the PC device. Since the arbitrary event is one of the plurality of scheduled events, the remote server sends an automated check-in request to the PC device when the current time matches the event time of the arbitrary event. Then, the remote server receives a check-in confirmation from the user account, wherein the check-in confirmation is associated to the arbitrary event. More specifically, the check-in confirmation includes a check-in time and a check-in location. The remote server then logs the check-in time and the check-in location for the user account so that both the user account and the administrative account can access them later for informational purpose. After the check-in time and the check-in location are logged within the present invention, the remote server designates a denial status or an approval status for the automated check-in request. More specifically, the denial status or the approval status is designated according to two different main categories that are described here in after.

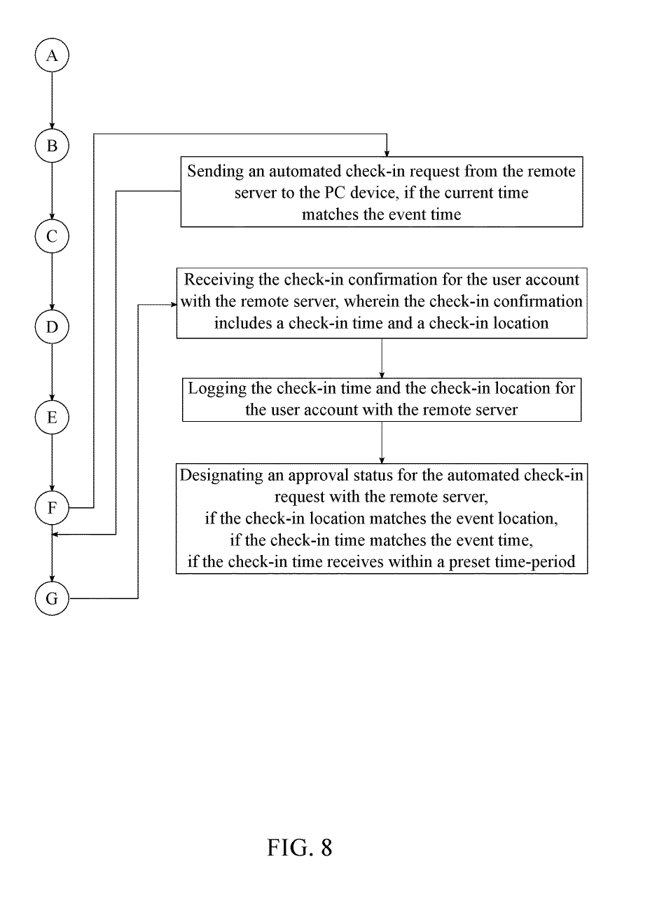

In reference to FIG. 8, the remote server designates the approval statues for the automated check-in request when the check-in location matches the event location, the check-in time matches the event time, and the check-in time receives within a preset time-period defined within the present invention. The preset time is preferably set to 60 seconds as the default time-period and can be changed upon the discretion of the administrative account or the presiding probation officer.

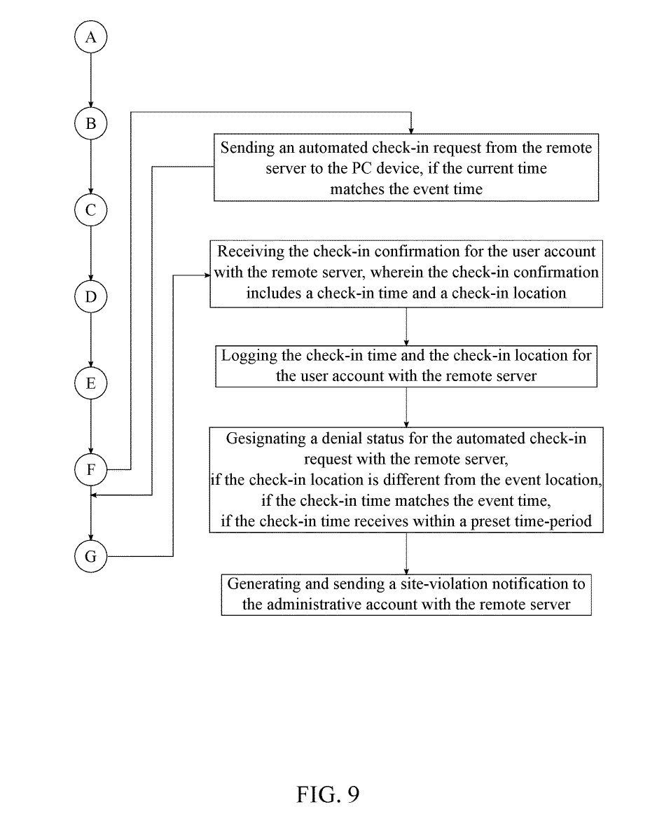

In reference to FIG. 9, the remote server designates the denial statues for the automated check-in request when the check-in location is different from the event location, the check-in time matches the event time, and the check-in time receives within the preset time-period. As a result, the remote server generates and sends a site-violation notification to the administrative account so that the remote server is able to keep track of the denial status with respect to the incorrect check-in location.

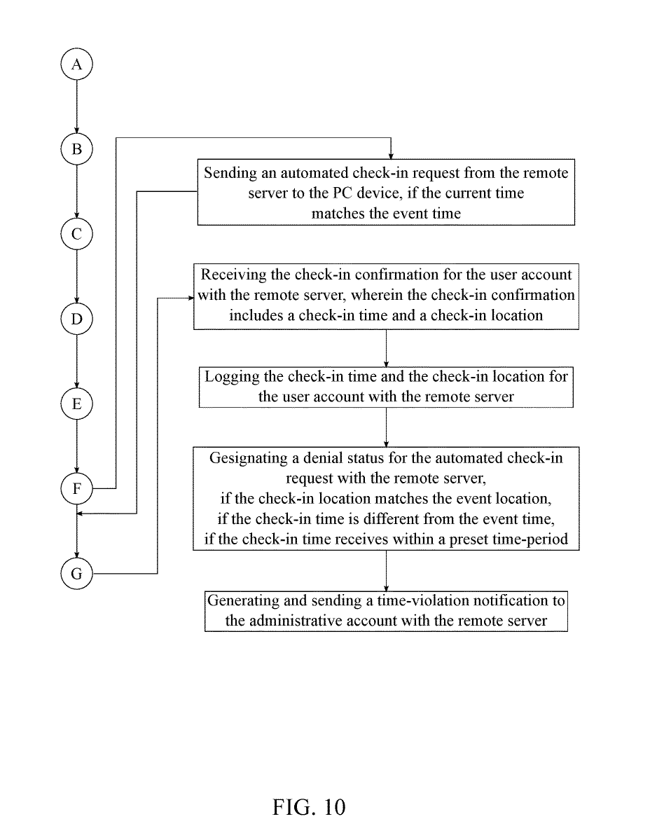

In reference to FIG. 10, the remote server designates the denial statues for the automated check-in request when the check-in location matches the event location, the check-in time is different from the event time, and the check-in time receives within the preset time-period. As a result, the remote server generates and sends a time-violation notification to the administrative account so that the remote server is able to keep track of the denial status with respect to the incorrect check-in time.

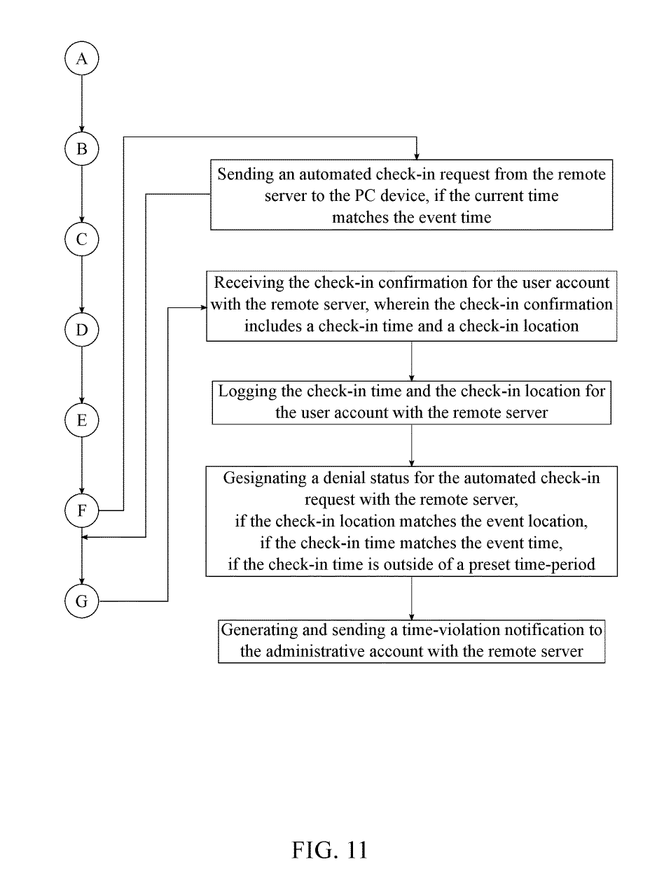

In reference to FIG. 11, the remote server designates the denial statues for the automated check-in request when the check-in location matches the event location, the check-in time matches the event time, and the check-in time is outside of the preset time-period. As a result, the remote server generates and sends a time-violation notification to the administrative account so that the remote server is able to keep track of the denial status with respect to the incorrect check-in time and the incorrect check-in location.

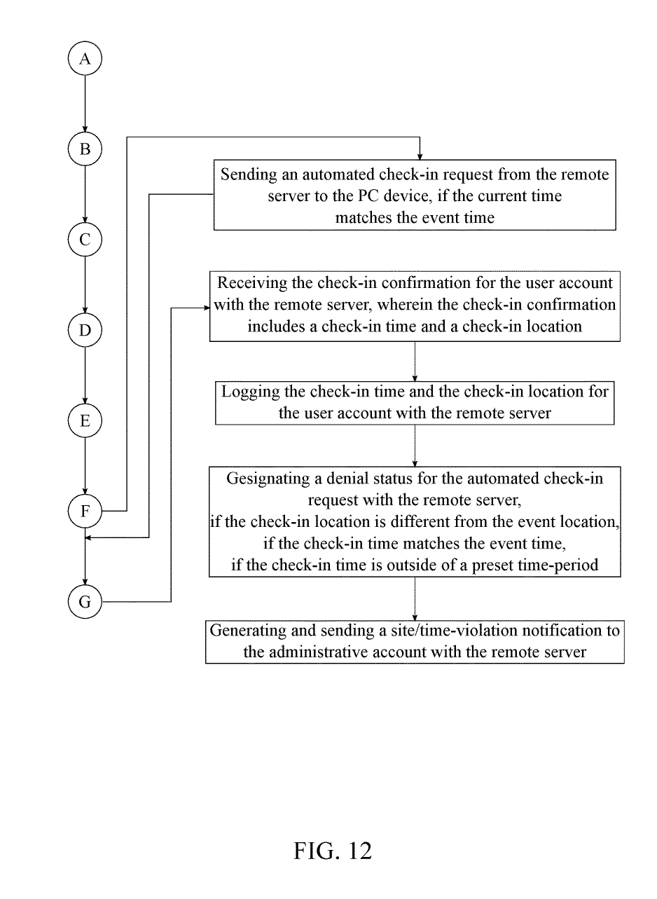

In reference to FIG. 12, the remote server designates the denial statues for the automated check-in request when the check-in location is different from the event location, the check-in time matches the event time, and the check-in time is outside of the preset time-period. As a result, the remote server generates and sends a site/time-violation notification to the administrative account so that the remote server is able to keep track of the denial status with respect to the incorrect check-in time and the incorrect check-in location.

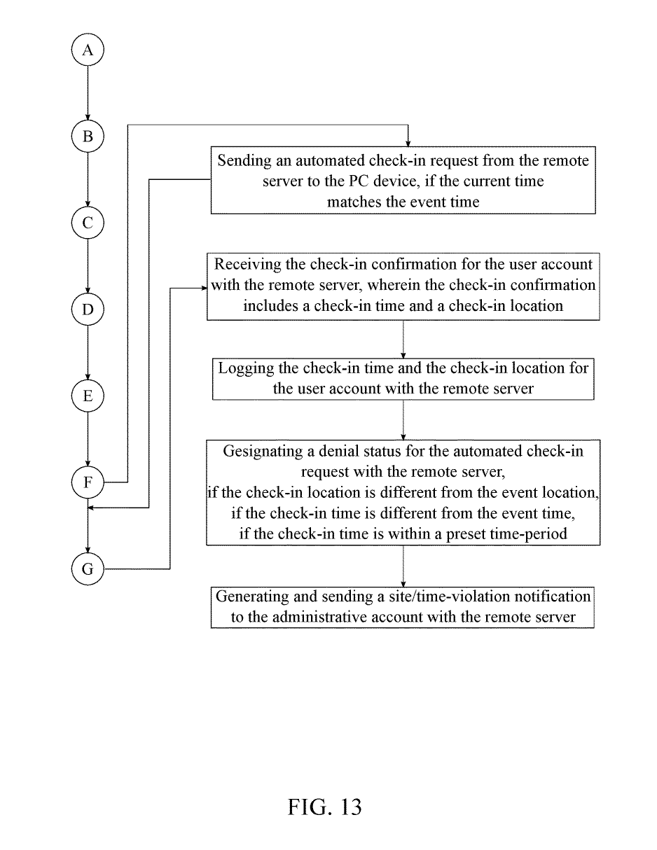

In reference to FIG. 13, the remote server designates the denial statues for the automated check-in request when the check-in location is different from the event location, the check-in time is different from the event time, and the check-in time is within the preset time-period. As a result, the remote server generates and sends a site/time-violation notification to the administrative account so that the remote server is able to keep track of the denial status with respect to the incorrect check-in time and the incorrect check-in location.

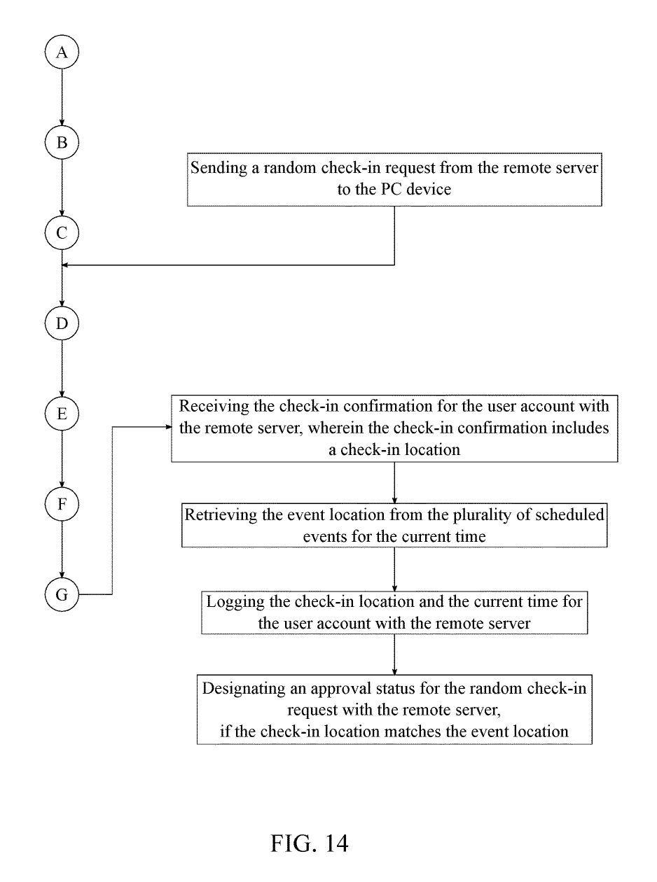

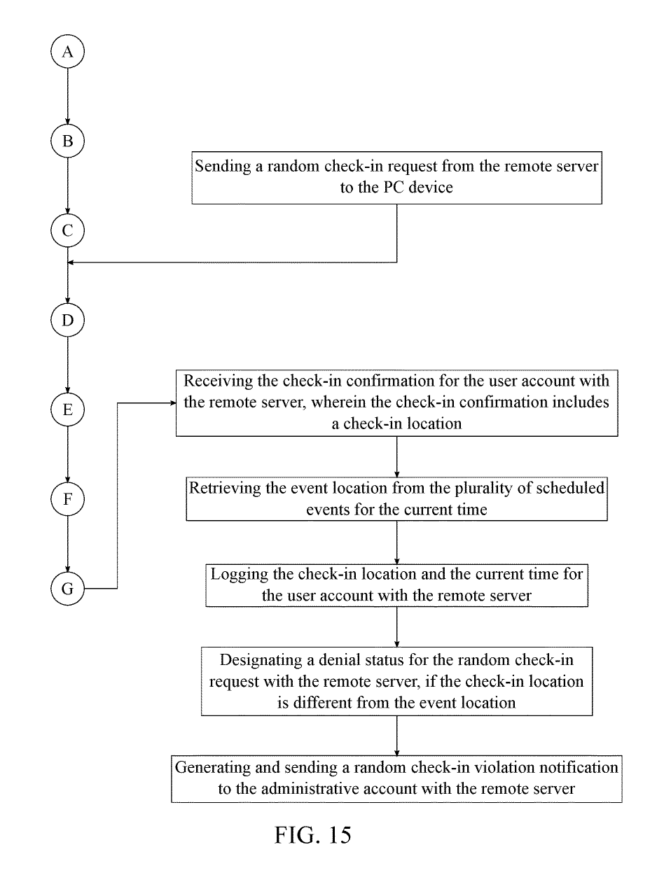

In reference to FIG. 14-15, the remote server sends a random check-in request to the PC device so that the present invention can execute random check-in feature for the user account. The remote server then receives and logs the check-in confirmation from the user account, wherein the check-in confirmation includes the check-in location so that both the user account and the administrative account can access them later for informational purpose. After the check-in location is logged within the present invention, the remote server retrieves the event location from the plurality of scheduled event that corresponds to the current time. The remote server then designates the denial status or the approval status for the random check-in request. More specifically, the remote server designates the approval status for the random check-in request if the check-in location matches the event location. However, when the check-in location is different from the event location, the remote server designates the denial status for the random check-in request. As result of the denial status, the remote server then generates and sends a random check-in violation notification to the administrative account so that the remote server is able to keep track of the denial status with respect to the incorrect check-in location.

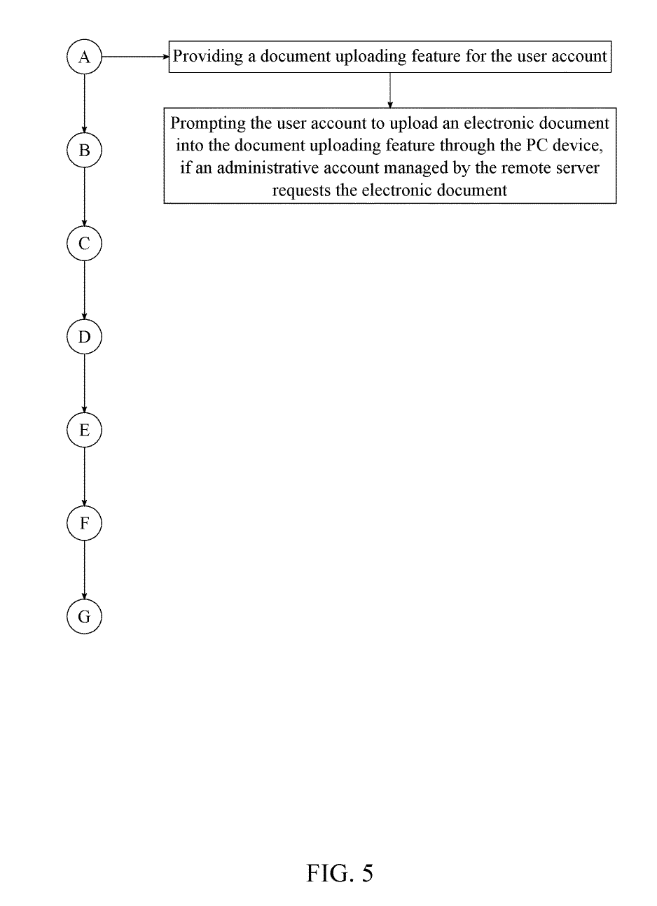

In reference to FIG. 5, the present invention also provides a document uploading feature that allows the user account to upload relevant document. Preferably, the user account is allowed to upload only media files and no other file format. More specifically, the remote server prompts the user account to upload an electronic document into the document uploading feature through the PC device when the administrative account requests the electronic document. The electronic document can include, but is not limited to, any court documents, any supporting document, and depositions.

Although the invention has been explained in relation to its preferred embodiment, it is to be understood that many other possible modifications and variations can be made without departing from the spirit and scope of the invention as hereinafter claimed.

What is claimed is:

1. A method of remotely monitoring and tracking individual under probation and/or house arrest comprises the steps of:
(A) providing a user account managed by at least one remote server, wherein the user account is associated with a personal computing (PC) device;
(B) tracking a current time with the remote server;
(C) managing a plurality of scheduled events for the user account with the remote server, wherein each scheduled event includes an event time and an event location;
(D) prompting the user account to track a current location of the PC device, before the current time matches the event time of an arbitrary event, wherein the arbitrary event is one of the plurality of scheduled events;
(E) tracking a geospatial path of the PC device, until the current location of the PC device matches the event location of the arbitrary event;
(F) prompting the user account to check-in at the event location of the arbitrary event through the PC device; and
(G) receiving and logging a check-in confirmation for the user account with the remote server, wherein the check-in confirmation is associated to the arbitrary event.

2. The method of remotely monitoring and tracking individual under probation and/or house arrest as claimed in claim 1 comprises the steps of:
providing a user profile for the user account;
prompting the user account to upload personal information through the PC device, wherein the personal information includes a profile picture, a personal identification, a first name, a middle name, a last name, a previous married name, a material status, a date of birth, a primary contact number, a second contact number, and an email address; and
receiving the personal information for the user account with the remote server to complete the user profile.

3. The method of remotely monitoring and tracking individual under probation and/or house arrest as claimed in claim 1, wherein the personal identification is a biometric identification.

4. The method of remotely monitoring and tracking individual under probation and/or house arrest as claimed in claim 1, wherein the personal identification is a social security number.

5. The method of remotely monitoring and tracking individual under probation and/or house arrest as claimed in claim 1 comprises the steps of:
providing a case profile for the user account;
providing an administrative account managed by the remote server, wherein the administrative account is associated with an administrative computing (AC) device;
prompting the user account to upload case information through the PC device, wherein the case information includes an arrest number, an arrest type, a name registry, a judge registry, a lawyer registry, and a probation office registry;
sending a processing status to the user account with the remote server,
if the case information is submitted through the PC device;
generating and sending a case request to the administrative account with the remote server, wherein the case request is associated with the case information; and
prompting the administrative account to authenticate the case information through the AC device to complete the case profile.

6. The method of remotely monitoring and tracking individual under probation and/or house arrest as claimed in claim 5, wherein the arrest type is designated as house arrest, and wherein the event location for a large set of the plurality of scheduled events is restricted to a home address of the user account.

7. The method of remotely monitoring and tracking individual under probation and/or house arrest as claimed in claim 5, wherein the arrest type is designated as probation, and wherein the event location for a large set of the plurality of scheduled events is unrestricted to a home address of the user account.

8. The method of remotely monitoring and tracking individual under probation and/or house arrest as claimed in claim 1 comprises the steps of:
providing payment options for the user account;
prompting the user account to select a desired payment plan from the payment options through the PC device;
prompting the user account to upload a payment method for the desired payment plan through the PC device; and
processing the payment method for the user account with the remote server.

9. The method of remotely monitoring and tracking individual under probation and/or house arrest as claimed in claim 1 comprises the steps of:
providing a document uploading feature for the user account; and
prompting the user account to upload an electronic document into the document uploading feature through the PC device,
if an administrative account managed by the remote server requests the electronic document.

10. The method of remotely monitoring and tracking individual under probation and/or house arrest as claimed in claim 1 comprises the steps of:
providing a schedule for the user account;
providing an administrative account managed by the remote server, wherein the administrative account is associated with an administrative computing (AC) device;
prompting the user account to upload the event time and the event location of each scheduled event to the schedule through the PC device;
allocating the event time and the event location of each scheduled event into the schedule of the user account with the remote server;
sending a schedule completion notification to the administrative account with the remote server, after a last scheduled event for the plurality of scheduled events is allocated to the schedule;
prompting the administrative account to authenticate each scheduled event for the user account through the AC device to complete the case profile; and
displaying each scheduled event to the user account through the PC device.

11. The method of remotely monitoring and tracking individual under probation and/or house arrest as claimed in claim 1 comprises the steps of:
providing a schedule for the user account;
providing an administrative account managed by the remote server, wherein the administrative account is associated with an administrative computing (AC) device;
prompting the administrative account to upload the event time and the event location of each scheduled event to the schedule through the AC device;
allocating the event time and the event location of each scheduled event into the schedule of the user account with the remote server; and
displaying each scheduled event to the user account through the PC device.

12. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server, wherein the check-in confirmation includes a check-in time and a check-in location during step (G);
logging the check-in time and the check-in location for the user account with the remote server; and
designating an approval status for the automated check-in request with the remote server,
if the check-in location matches the event location,
if the check-in time matches the event time,
if the check-in time receives within a preset time-period.

13. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server, wherein the check-in confirmation includes a check-in time and a check-in location during step (G);
logging the check-in time and the check-in location for the user account with the remote server;
designating a denial status for the automated check-in request with the remote server,
if the check-in location is different from the event location,
if the check-in time matches the event time,
if the check-in time receives within a preset time-period; and
generating and sending a site-violation notification to the administrative account with the remote server.

14. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server during step (G), wherein the check-in confirmation includes a check-in time and a check-in location;
logging the check-in time and the check-in location for the user account with the remote server;
designating a denial status for the automated check-in request with the remote server,
if the check-in location matches the event location,
if the check-in time is different from the event time,
if the check-in time receives within a preset time-period; and
generating and sending a time-violation notification to the administrative account with the remote server.

15. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server during step (G), wherein the check-in confirmation includes a check-in time and a check-in location;
logging the check-in time and the check-in location for the user account with the remote server;
designating a denial status for the automated check-in request with the remote server,
if the check-in location matches the event location,
if the check-in time matches the event time,
if the check-in time is outside of a preset time-period; and
generating and sending a time-violation notification to the administrative account with the remote server.

16. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server during step (G), wherein the check-in confirmation includes a check-in time and a check-in location;
logging the check-in time and the check-in location for the user account with the remote server;
designating a denial status for the automated check-in request with the remote server,
if the check-in location is different from the event location,
if the check-in time matches the event time,
if the check-in time is outside of a preset time-period; and
generating and sending a site/time-violation notification to the administrative account with the remote server.

17. The method of remotely monitoring and tracking individual under probation and/or house arrest as claimed in claim 1 comprises the steps of:
sending an automated check-in request from the remote server to the PC device during step (F), if the current time matches the event time;
receiving the check-in confirmation for the user account with the remote server during step (G), wherein the check-in confirmation includes a check-in time and a check-in location;
logging the check-in time and the check-in location for the user account with the remote server;
designating a denial status for the automated check-in request with the remote server,
if the check-in location is different from the event location,
if the check-in time is different from the event time,
if the check-in time is within a preset time-period; and
generating and sending a site/time-violation notification to the administrative account with the remote server.

18. The method of remotely monitoring and tracking individual under probation and/or house arrest as claimed in claim 1 comprises the steps of:
sending a random check-in request from the remote server to the PC device, after step (C);
receiving the check-in confirmation for the user account with the remote server during step (G), wherein the check-in confirmation includes a check-in location;
retrieving the event location from the plurality of scheduled events for the current time;
logging the check-in location and the current time for the user account with the remote server; and
designating an approval status for the random check-in request with the remote server,
if the check-in location matches the event location.

19. The method of remotely monitoring and tracking individual under probation and/or house arrest as claimed in claim 1 comprises the steps of:
sending a random check-in request from the remote server to the PC device, after step (C);
receiving the check-in confirmation for the user account with the remote server during step (G), wherein the check-in confirmation includes a check-in location;
retrieving the event location from the plurality of scheduled events for the current time;
logging the check-in location and the current time for the user account with the remote server;
designating a denial status for the random check-in request with the remote server,
if the check-in location is different from the event location; and
generating and sending a random check-in violation notification to the administrative account with the remote server.
